(19) United States
(12) Patent Application Publication
(10) Pub. No.: US 2009/0046388 A1
(43) Pub. Date: Feb. 19, 2009

(54) HEAD SLIDER HAVING LUBRICANT LAYER ON ITS FLOATING SURFACE

(75) Inventors: Susumu Ogata, Kawasaki (JP); Hiroshi Chiba, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/190,891

(22) Filed: Aug. 13, 2008

(30) Foreign Application Priority Data
Aug. 15, 2007 (JP) 2007-211772

(51) Int. Cl. G11B 5/60

(52) U.S. Cl. 360/234.3

(57) ABSTRACT

A head slider that includes a slider body having a air bearing surface, a magnetic head provided on the slider body, and a lubricant layer disposed on the air bearing surface, the lubricant layer being composed of a fluorocarbon resin.

### CROSS-REFERENCE TO RELATED APPLICATIONS

This application is based upon and claims the benefit of priority from the prior Japanese Patent Application No. 2007-211772, filed on Aug. 15, 2007 the entire contents of which are incorporated herein by reference.

### TECHNICAL FIELD

The present invention relates to a head slider having a lubricant layer on the surface facing a magnetic disk, a magnetic disk device on which the head slider is mounted, and a method for producing the head slider.

### BACKGROUND

In a typical magnetic disk device, a head slider may come into contact with a surface of a magnetic disk (magnetic recording medium), and the surface of the magnetic disk may be damaged by the impact at the time of contact. In order to protect the surface of the magnetic disk from such damage, generally, a film composed of a lubricant is provided on the surface of the magnetic disk. However, such a film is gradually abraded due to friction with the head slider, and finally, some portions of the surface of the magnetic disk may be exposed. In such portions, the magnetic body in the magnetic disk is easily damaged, in the worst case, resulting in a head crash.

In order to prolong the life of magnetic disks, it is effective to increase the period of time until a head crash occurs. However, as the recording density of magnetic disk devices increases, it becomes necessary to decrease the gap between the head and the disk. Accordingly, the thickness of the film composed of a lubricant must be decreased. Under these circumstances, as a method for increasing the period of time until a head crash occurs, a technique is known in which a film composed of a lubricant is also provided on the head slider. Hereinafter, such a film composed of a lubricant may also be referred to as a “lubricant layer”.

With respect to the technique in which a film composed of a lubricant is provided, a structure has been disclosed in which a lubricant layer is bonded over the entirety of a surface facing a magnetic disk (hereinafter may be referred to as “air bearing surface” or “floating surface” of a head slider. The lubricant layer is located between the surface of the magnetic disk and the head slider, and functions as a buffer that prevents damage to the surface of the disk.

In recent years, the fly height of a magnetic head above a magnetic disk has been gradually decreased, and devices with a fly height of 10 nm or less have also been under development. As the fly height decreases, head sliders come into contact with the surface of the magnetic disk with increasing frequency. Consequently, the speed of reduction in thickness of the film composed of a lubricant or the lubricant layer due to abrasion increases, and the period of time until a head crash occurs is shortened.

Furthermore, with the decrease in the fly height of a magnetic head, the distance between the magnetic head and the magnetic body in the magnetic disk decreases. Consequently, it is not possible to form a lubricant layer provided on the air bearing surface of a head slider at a desired thickness. If the thickness of the lubricant layer is small, the lubricant layer is completely removed in a short period of time, and after that, the buffering effect does not take place. The speed of reduction in thickness of the lubricant layer cannot be decreased anymore. Such a decrease in the fly height of the magnetic head results in a situation in which it is difficult to ensure a sufficient period of time until a disk crash occurs.

As described above, in the known technique, it is difficult to ensure a sufficient period of time until a head crash occurs.

### SUMMARY

According to one aspect of the present invention, a head slider includes a slider body having an air bearing surface, a magnetic head provided on the slider body, and

a lubricant layer bonded on the air bearing surface, the lubricant layer being composed of a fluorocarbon resin.

### BRIEF DESCRIPTION OF THE DRAWINGS

FIG. 1 is a plan view showing an inside of a magnetic disk device according to a first embodiment;

FIGS. 2A and 2B are views showing a magnetic head support according to the first embodiment;

FIGS. 3A and 3B are views showing outline shapes of a slider according to the first embodiment;

FIG. 4 is a view showing a positional relationship between the slider and a magnetic disk according to the first embodiment;

FIGS. 5A to 5E are schematic views showing a method for forming a lubricant layer on a head slider;

FIG. 6 includes a table which shows changes in surface wettability of a slider which has been subjected to treatment of Steps 1 to 3;

FIG. 7 is a view of a model showing a state of a lubricant layer which has been subjected to treatment of Steps 1 to 3;

FIGS. 8A and 8B are views showing a mechanism in which a resin attached to a surface of a lubricant layer moves;

FIG. 9 includes a graph showing the results after treatment of Steps 1 to 3;

FIG. 10 is a graph showing a relationship between the thickness of the lubricant layer and the surface free energy of the surface of a slider provided with the lubricant layer; and

FIG. 11 is a view showing a slider according to a second embodiment.

### DETAILED DESCRIPTION OF THE EMBODIMENTS

### First Embodiment

### Magnetic Disk Device

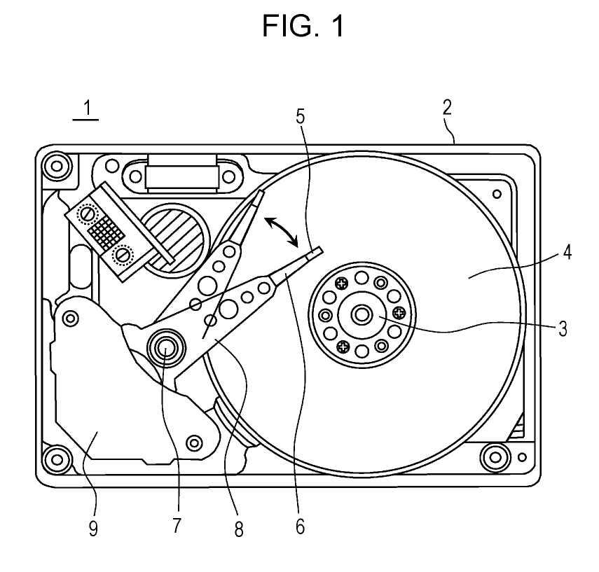

An example of a magnetic disk device of the present invention will be described with reference to FIG. 1. FIG. 1 is a plan view showing an inside of a magnetic disk device according to a first embodiment of the present invention.

A magnetic disk device 1 shown in FIG. 1 is a hard disk drive (HDD) and includes a housing 2 as an outer package. The magnetic disk device 1 includes, in the housing 2, a magnetic disk 4 which is mounted on and rotates around a spindle 3, a slider 5 on which a magnetic head is mounted, the magnetic head writing and reading information in and from the magnetic disk 4, a suspension 6 which holds the slider 5, a carriage arm 8 on which the suspension 6 is fixed and which pivots about an arm axis 7 and moves along the surface of the magnetic disk 4, and an electromagnetic actuator 9 which drives the carriage arm 8. A cover (not shown) is disposed on the housing 2, and the components described above are accommodated in an inner space formed by the housing 2 and the cover. The slider 5 is also referred to as a “head slider”. Furthermore, the slider 5 is composed of an AlTiC material. The AlTiC material is a ceramic obtained by firing alumina (Al₂O₃) and titanium carbide (TiC).

—Magnetic Head Support—

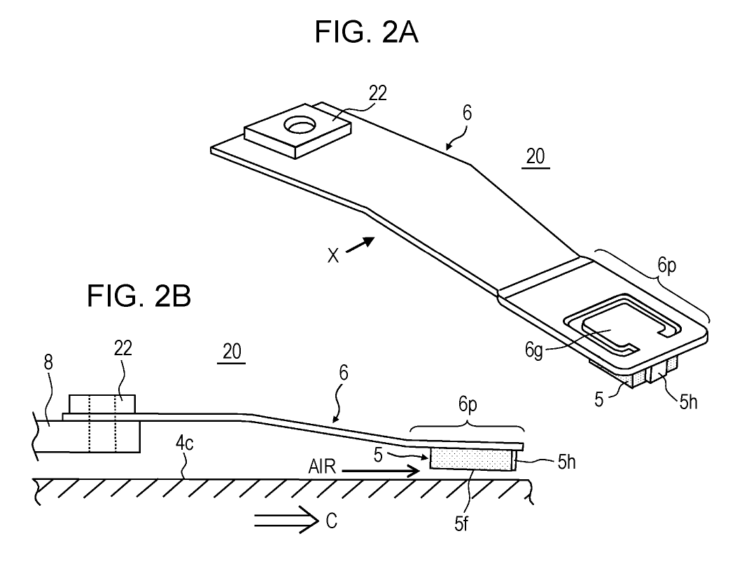

An example of a magnetic head support of the present invention will be described with reference to FIGS. 2A and 2B. Note that the magnetic head support may be referred to as a head gimbal assembly (HGA). FIG. 2A is a perspective view of a magnetic head support according to the first embodiment of the present invention, and FIG. 2B is a side view of the magnetic head support viewed from the X direction shown in FIG. 2A.

Referring to FIGS. 2A and 2B, in general, a magnetic head support 20 is a structure in which a base plate 22, a slider 5, etc. are fixed on a suspension 6. In some cases, the suspension 6 before the base plate 22 and the slider 5 are fixed thereon, i.e., the suspension 6 only, may be referred to as the magnetic head support 20. Furthermore, in some cases, a structure in which either the base plate 22 or the slider 5 is fixed on the suspension 6 may be referred to as the magnetic head support 20.

The suspension 6 is, for example, a plate-like member composed of stainless steel with a thickness of 20 μm. As shown in the drawings, the base plate 22 is bonded to one end on the carriage arm 8 side of the suspension 6, and the slider 5 is fixed on a tip portion 6p on the other end. Specifically, the slider 5 provided with a magnetic head 5h is fixed on a gimbal 6g disposed on the tip portion 6p of the suspension 6 so as to be placed at a position facing a surface 4c of a magnetic disk.

As shown in FIG. 2B, the magnetic head 5h is disposed on an end of the slider 5. When the magnetic disk is rotated in a direction indicated by the arrow C, air flows in under a air bearing surface 5f of the slider 5 in the arrow “Air” direction shown in FIG. 2B. Buoyancy is imparted to the slider 5 by the airflow, and the slider 5 flies on the surface 4c of the magnetic disk. Furthermore, since slight irregularities are present on the surface 4c of the magnetic disk, the slider 5 may come into contact with the surface 4c of the magnetic disk while the magnetic disk is rotated.

—Slider—

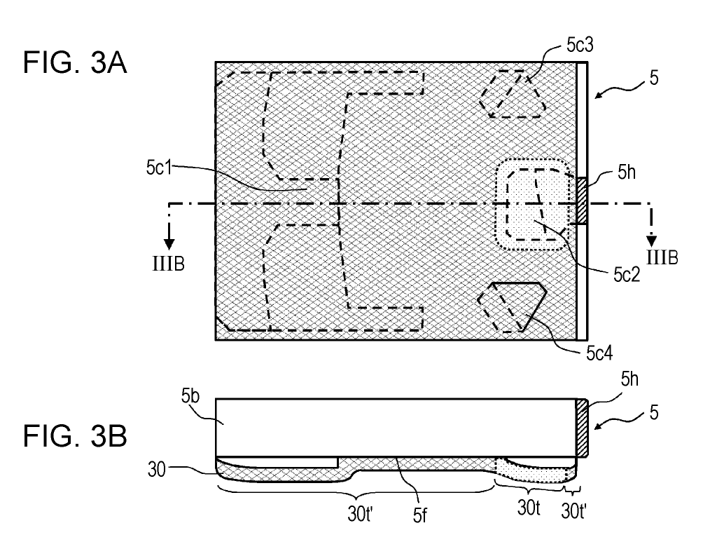

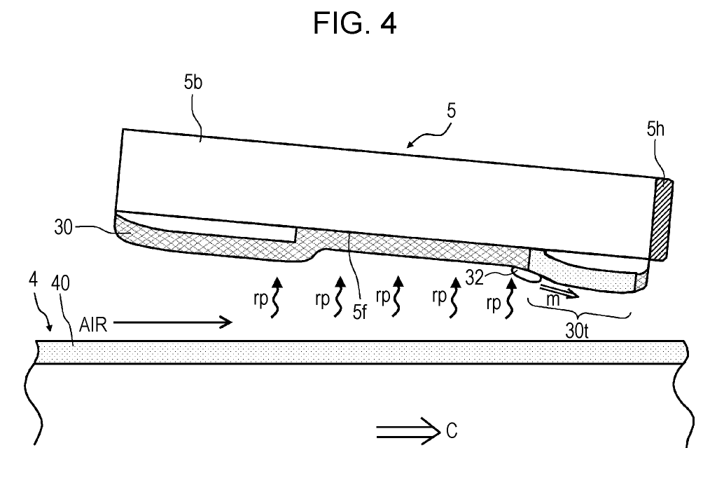

The slider 5 according to this embodiment will be described with reference to the drawings. FIGS. 3A and 3B are views showing outline shapes of the slider 5 according to this embodiment. FIG. 3A is a plan view of the slider 5 viewed from the air bearing surface 5f, and FIG. 3B is a cross-sectional view of the slider 5 taken along the line IIIB-IIIB of FIG. 3A. FIG. 4 is a view showing a positional relationship between the slider 5 and the magnetic disk 4 according to this embodiment.

As shown in FIG. 3A, the air bearing surface 5f of the slider 5 has protrusions 5c1 to 5c4 so that the buoyancy imparted to the slider 5 and the floating direction of the slider 5 can be adjusted. The protrusions 5c1 to 5c4 are portions that protrude from the surrounding flat surface as shown in FIG. 3B. Four protrusions 5c1 to 5c4 are disposed on the slider 5 according to this embodiment. The protrusion 5c1 is disposed on an air inflow side of the slider 5, and the protrusions 5c2 to 5c4 are disposed on an air outflow side. Furthermore, a lubricant layer 30 composed of a resin is disposed on the air bearing surface 5f of a slider body 5b so as to cover the protrusions 5c1 to 5c4. The resin constituting the lubricant layer 30 is, for example, a fluorocarbon resin. More specifically, as the fluorocarbon resin, for example, a perfluoropolyether is used.

As shown in FIG. 3B, the lubricant layer 30 is bonded over the entire air bearing surface 5f of the slider 5. A region 30t of the lubricant layer 30 has a higher value indicating wettability than a region 30t′, which is a region other than the region 30t (i.e., a region surrounding the region 30t). In such a manner, the lubricant layer 30 has regions having different surface wettability properties. As the value indicating wettability, for example, surface tension, surface free energy (SFE), or the like can be used. In the slider 5, the relationship γ>γ′ is satisfied, where γ is the SFE value of the region 30t and γ′ is the SFE value of the region 30t′.

The positional relationship between the slider 5 and the magnetic disk 4 will now be described with reference to FIG. 4. First, the magnetic disk 4 will be described. As shown in FIG. 4, a lubricant film 40 is applied on the surface of the magnetic disk 4. The surface of the magnetic disk 4 is protected from impact from outside or the like by the lubricant film 40. The lubricant film 40 has, for example, a thickness of 0.9 nm. As a material for the lubricant constituting the lubricant film 40, for example, a perfluoropolyether represented by chemical formula (1) below may be used.

R—[(O—CF₂—CF₂)m-(O—CF₂)n]—O—R (1)

In chemical formula (1), R is an end group, and m and n are each a real numbers equal to or greater than zero. In the perfluoropolyether, as the end group R, for example, a hydroxyl-containing polar group (—CH₂OH, or —CH₂—O—CH₂—O—CH(OH)—CH₂—OH) may be used.

When the magnetic disk 4 starts to rotate in a direction indicated by the arrow C, as shown in FIG. 4, under the action of inflow air, the slider 5 flies while being slightly inclined such that the magnetic head 5h comes close to the surface of the magnetic disk 4. As shown in FIG. 4, in the head slider 5 according to this embodiment, the magnetic head 5h is mounted on the air outflow side. Molecules of the lubricant evaporated from the lubricant film 40 applied on the surface of the magnetic disk 4 are present inside the housing 2 of the magnetic disk device 1. As indicated by the arrows rp in FIG. 4, the molecules of the lubricant are attached to the surface of the lubricant layer 30 bonded on the air bearing surface 5f of the head slider 5. Then, the attached lubricant 32 moves in a direction indicated by the arrow m.

For example, the SFE value of the surface of the lubricant film 40 is 17 [mN/m], and the SFE value of the air bearing surface 5f of the head slider 5 on which the lubricant layer 30 is bonded is 22 [mN/m]. Some of the molecules of the lubricant present inside the housing 2 attach to and evaporate from the surfaces of the lubricant film 40 and the lubricant layer 30 repeatedly. Consequently, in order to increase the attachment rate of the molecules of the lubricant present inside the housing 2 to the lubricant layer 30, preferably, the SFE value of the air bearing surface 5f of the head slider 5 on which the lubricant layer 30 is bonded is set to be larger than or brought as close as possible to the SFE value of the surface of the lubricant film 40. By employing such a structure, a larger amount of molecules of the lubricant attaches to the lubricant layer 30 side having higher wettability. As a result, when the lubricant evaporates from the surface of the lubricant film 40, attachment of the molecules of the lubricant to the lubricant layer 30 is accelerated, and the lubricant 32 is continuously supplied to the surface of the lubricant layer 30.

—Method for Forming Lubricant Layer on Head Slider—

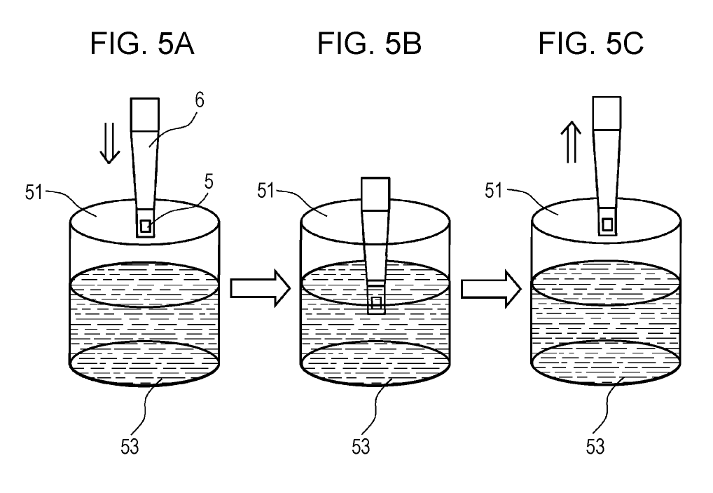

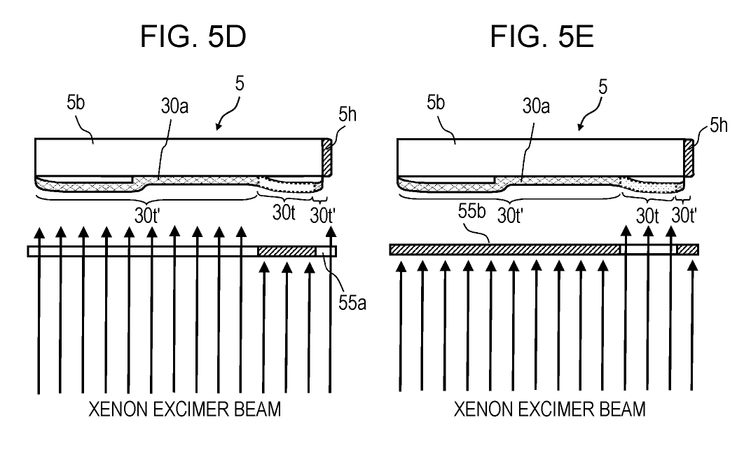

A method for forming the lubricant layer 30 on the head slider 5 according to this embodiment will now be described. FIGS. 5A to 5C are schematic views showing a process of applying a fluorocarbon resin to the head slider 5, and FIGS. 5D and 5E are schematic views showing a process of irradiating the applied fluorocarbon resin with ultraviolet light. The method for forming the lubricant layer 30 includes, for example, three steps, i.e., a resin application step, an energy ray irradiation step, and a nonbonded resin removal step.

Step 1: Resin Application Step

In this step, as shown in FIGS. 5A to 5C, a film of a resin is formed on the surface of the slider 5 using an immersion process. First, as shown in FIG. 5A, a container 51 in which a resin solution 53 is placed is prepared. Next, as shown in FIG. 5B, the slider 5 is immersed in the resin solution 53. The immersion step is performed, for example, in a state where the slider 5 is fixed on the suspension 6. Next, as shown in FIG. 5C, the slider 5 is withdrawn from the resin solution 53. In such a manner, a film (not shown) composed of the resin is formed over the entire surface of the slider 5. In this embodiment, as the resin solution, for example, a solution of a perfluoropolyether represented by chemical formula (1) above may be used. In the perfluoropolyether, as the end group R, for example, a trifluoromethyl group (—CF₃) or a hydroxyl-containing polar group (—CH₂OH or —CH₂—O—CH₂—O—CH(OH)—CH₂—OH) may be used.

Step 2: Energy Ray Irradiation Step

In this step, as shown in FIGS. 5D and 5E, a film 30a composed of the resin applied in Step 1 is irradiated with

In this step, as shown in FIGS. 5D and 5E, a film 30a composed of the resin applied in Step 1 is irradiated with an energy ray. Specifically, first, as shown in FIG. 5D, a photomask 55a is prepared so that a region 30t, which lies near the magnetic head 5h, is shielded from light. Using the photomask 55a, the film 30a composed of the resin is irradiated with an energy ray. As the energy ray, light having high energy, such as ultraviolet light, is effective. In this embodiment, as the energy ray, for example, xenon excimer light having a center wavelength of 172 nm is used. Irradiation with excimer light is performed, for example, for 10 seconds. As a result of the irradiation, in a region other than the region 30t (i.e., a region 30t′), the film 30a composed of the resin is cured and bonded to the surface of the slider 5.

Next, as shown in FIG. 5E, a photomask 55b is prepared so that the region 30t′ is shielded from light. Using the photomask 55b, irradiation with excimer light is performed again, for example, for 3 seconds. As a result of the irradiation, in the region 30t, the film 30a composed of the resin is cured and bonded to the surface of the slider 5. Note that the energy ray irradiation step is performed in a nitrogen atmosphere.

Step 3: Nonbonded Resin Removal Step

Finally, the resin not bonded to the surface of the slider 5 is removed. Specifically, the resin not bonded to the surface of the slider 5 is removed by an immersion method in which an etching solution is used as a solvent. In this embodiment, as the etching solution, for example, 2,3-dihydrodecafluoropentane is used. By removing the resin film not bonded to the surface of the slider 5 as described above, a lubricant layer 30 is formed on the air bearing surface 5f of the slider 5.

### Example 1

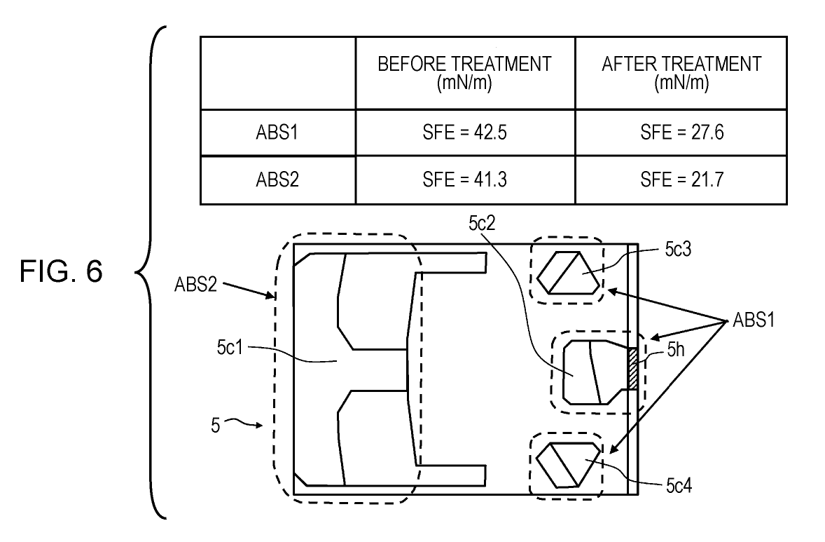

A slider 5 was actually prepared and subjected to treatment of Steps 1 to 3. FIG. 6 includes a table which shows changes in surface wettability of the slider 5 before and after treatment of Steps 1 to 3. As the slider 5, a slider having the same shape as that shown in FIGS. 3A and 3B was used, and as the value indicating wettability, the SFE value was used. In the table, ABS1 refers to a region including protrusions 5c2 to 5c4 on the air outflow side of the air bearing surface 5f, and ABS2 refers to a region including a protrusion 5c1 on the air inflow side of the air bearing surface 5f. “Before treatment” refers to a state before the treatment of Steps 1 to 3 was performed, and “after treatment” refers to a state after the treatment of Steps 1 to 3 was performed.

As is evident from the table of FIG. 6, the SFE value after treatment is lower than that before treatment in each of the ABS1 region and the ABS2 region. That is, the coated surface obtained by applying the fluorocarbon resin to the head slider 5 became easily wettable in each of the ABS1 region and the ABS2 region. In addition to this, a difference in the SFE value of about 6 [mN/m] occurred between the ABS1 region and the ABS2 region. Specifically, the SFE value in the ABS1 region was higher by about 6 [mN/m] than the SFE value in the ABS2 region, and the ABS1 region was more easily wettable than the ABS2 region. The difference is assumed to be caused by the fact that the amount of energy ray applied to the ABS2 region was bigger than the amount of energy ray applied to the ABS1 region.

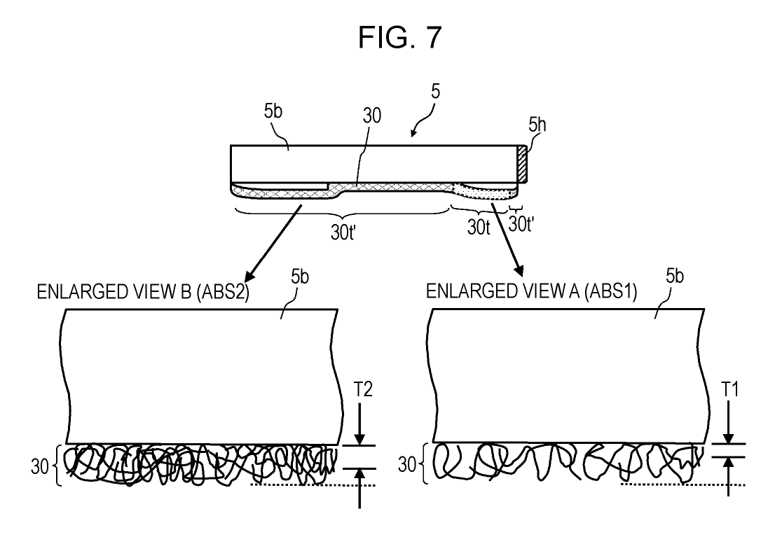

Furthermore, after the treatment of Steps 1 to 3, the thickness of the lubricant layer 30 was measured in each of the ABS1 region and the ABS2 region. The thickness T1 in the ABS1 region was 0.12 nm, and the thickness T2 of the ABS2 region was 0.27 nm. The thickness was measured using ellipsometry. The reason why the SFE value and the thickness differ depending on the irradiation amount of energy ray is not known. However, since the thickness depends on the molecular density of the film, the difference in the molecular density of the film in the lubricant layer 30 is considered likely to be a factor in causing the differences, as described below. The reason will be described with reference to FIG. 7, which is a view of a model showing a state of the lubricant layer 30 after the treatment of Steps 1 to 3 for the sake of explanation. As shown in FIG. 7, it is considered to be likely that, in the ABS2 region to which a large amount of energy ray has been applied (enlarged view B), the molecular density of the lubricant layer 30 is high, while in the ABS1 region to which a small amount of an energy ray has been applied (enlarged view A), the molecular density of the lubricant layer 30 is low. It is estimated that the differences in the thickness and the SFE value indicating wettability are caused by such a difference in the molecular density of the resin film.

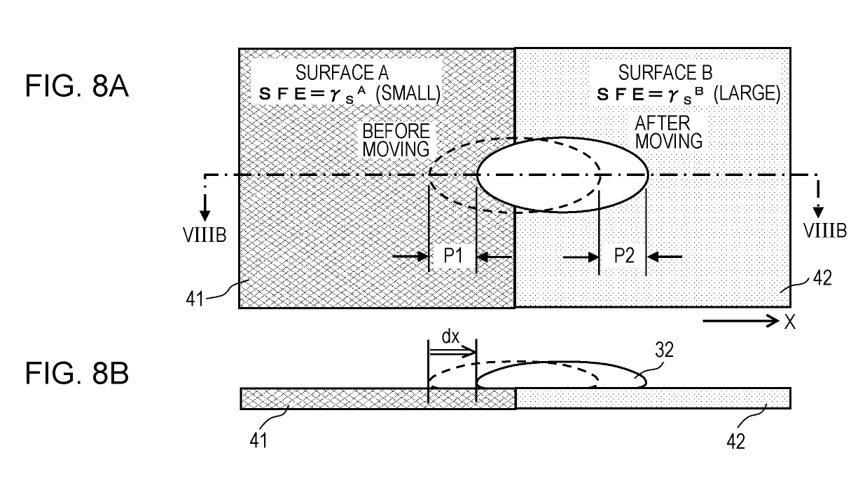

Next, a mechanism in which a lubricant 32 attached to the surface of the lubricant layer 30 moves on the surface due to the difference in the SFE value will be described. FIGS. 8A and 8B are views showing the mechanism. FIG. 8A is a plan view and FIG. 8B is a cross-sectional view taken along the line VIIIB-VIIIB of FIG. 8A. As shown in FIGS. 8A and 8B, a case is assumed where a member 41 having a surface A with a small SFE value indicating wettability (i.e., not easily wettable surface) is in contact with a member 42 having a surface B with a large SFE value indicating wettability (i.e., easily wettable surface). The surface free energy value of the surface A is defined as γSA, and the surface free energy value of the surface B is defined as γSB. In this case, a force F expressed by expression (A) below is applied to a lubricant 32 attached to the boundary between the surface A and the surface B.

$$F = 2 \sqrt{{γ}_{L}} {( \sqrt{{γ}_{S}^{B}} - \sqrt{{γ}_{S}^{A}} )}_{{}_{{A}^{′}}} \qquad ( A )$$

As shown in expression (A), as the difference between γSA and γSB increases, the portion A′ in expression (A) increases. Consequently, the force F that moves the lubricant 32 increases. In expression (A), γL is the SFE value of the lubricant 32.

Expressions (B) to (F) are calculation formulae for obtaining expression (A). First, in a state shown in FIGS. 8A and 8B, when the lubricant 32 moves in the X direction, the change in energy dU can be expressed as in expression (B) below.

dU=[(γ_{SL}^{B}−γ_{S}^{B})−(γ_{SL}^{A}−γ_{S}^{A})]dx (B)

In expression (B), γSL is the SFE value at the interface between the lubricant 32 and each of the members 41 and 42. Furthermore, γSL can be expressed as in expression (C) below.

γ_{SL}=γ_{S}+γ_{L}−2\sqrt{γ_{S}γ_{L}} (C)

When γS is subtracted from both sides, expression (C) can be changed to expression (D) below.

γ_{SL}−γ_{S}=(γ_{S}+γ_{L}−2\sqrt{γ_{S}γ_{L}})−γ_{S}=γ_{L}−2\sqrt{γ_{S}γ_{L}} (D)

Then, expression (D) is substituted into expression (B) to give expression (E) below.

$$\begin{matrix}d U = [ ( {γ}_{L} - 2 \sqrt{{γ}_{S}^{B} {γ}_{L}} ) - ( {γ}_{L} - \sqrt{{γ}_{S}^{A} {γ}_{L}} ) ] d x \\ = - 2 \sqrt{{γ}_{L}} ( \sqrt{{γ}_{S}^{B}} - \sqrt{{γ}_{S}^{A}} ) d x\end{matrix} \qquad ( E )$$

Finally, expression (F), namely, expression (A), can be derived from expression (E).

$$F = - \frac{d U}{d x} = {2 \sqrt{{γ}_{L}}}_{{}_{↑ — Const . ( > 0 )}} ( \sqrt{{γ}_{S}^{B}} - \sqrt{{γ}_{S}^{A}} ) \qquad ( F )$$

### Example 2

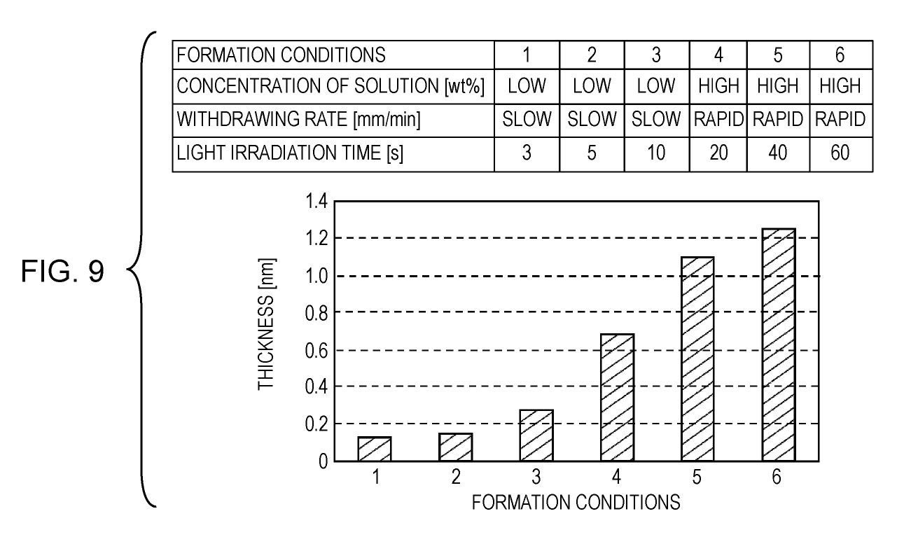

Under varied conditions, such as light irradiation time, lubricant layers 30 were formed, and the thickness of the lubricant layers 30 was measured. FIG. 9 includes the results of the measured thickness of the lubricant layers 30 which were formed by being subjected to treatment of Steps 1 to 3 under the formation conditions 1 to 6 in the table. The thickness was measured using known ellipsometry. As is evident from FIG. 9, regardless of the conditions, such as the concentration of the solution and the withdrawing rate, as the light irradiation time increases, the thickness of the lubricant layer 30 formed, increases.

### Example 3

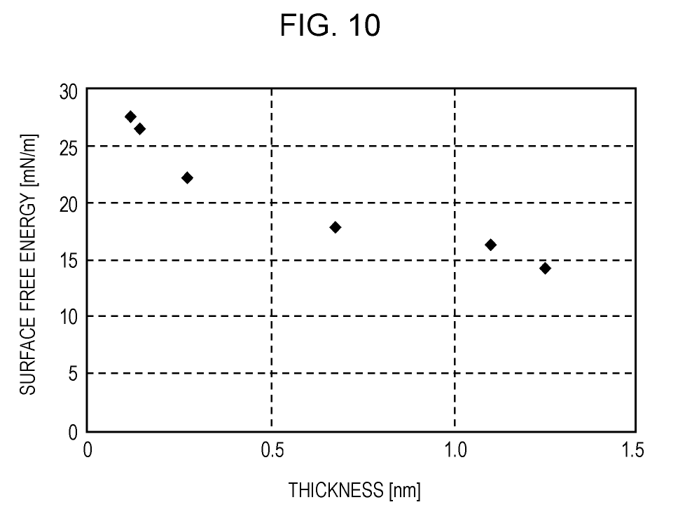

FIG. 10 is a graph showing a relationship between the thickness of the lubricant layer 30 and the surface free energy of the surface of a slider 5 provided with the lubricant layer 30. In this example, a slider 5 having a air bearing surface 5f with a SFE value of 42 [mN/m] was used. As is evident from the graph of FIG. 10, as the thickness of the lubricant layer 30 decreases, the SFE value of the lubricant layer 30 tends to increase. The thickness of the lubricant layer 30 in FIG. 10 was measured using known ellipsometry as in Example 2. Furthermore, the SFE value was obtained by calculation using the known Fowkes equation. Note that the calculation method using the Fowkes equation is disclosed in paragraphs [0051] to [0058] of US Laid-open Patent Publication No. US2005/0264937 (paragraphs [0041] to [0048] of Japanese Laid-open Patent Publication No. 2006-12377).

Comparative Experiment

Next, a case where treatment of Steps 1 to 3 was performed and a case where the treatment was not performed were compared. First, a slider 55 (not shown) which was subjected to treatment of Steps 1 to 3 and a slider 56 (not shown) which was not subjected to treatment of Steps 1 to 3 were prepared. With respect to the slider 56 which was not subjected to treatment of Steps 1 to 3, after a resin application step (Step 1) was performed, in an energy ray irradiation step (Step 2), the resin applied in Step 1 was entirely irradiated with xenon excimer light, having a wavelength of 172 nm, for 10 seconds. That is, by irradiating the entire surface provided with the lubricant layer 30 with the same amount of ultraviolet light, the value indicating wettability was set to be uniform over the surface provided with the lubricant layer 30. As a result, the air bearing surface of the slider 56 entirely had substantially the same wettability.

Next, the durability of each of the slider 55 and the slider 56 was measured. Specifically, with the slider (slider 55 or 56) being in contact with a magnetic disk 4, the magnetic disk 4 was rotated, and the period of time until the magnetic disk 4 was damaged was measured. The measurement was performed under the environment lower than the atmospheric pressure.

As a result, the slider 56, of comparative example, which was not subjected to treatment of Steps 1 to 3, was damaged when the magnetic disk 4 was rotated 59,100 times. In contrast, the slider 55 which was subjected to treatment of Steps 1 to 3 was damaged when the magnetic disk 4 was rotated 81,400 times. Thus, it has been confirmed that by performing treatment according to this embodiment, durability is enhanced.

### Second Embodiment

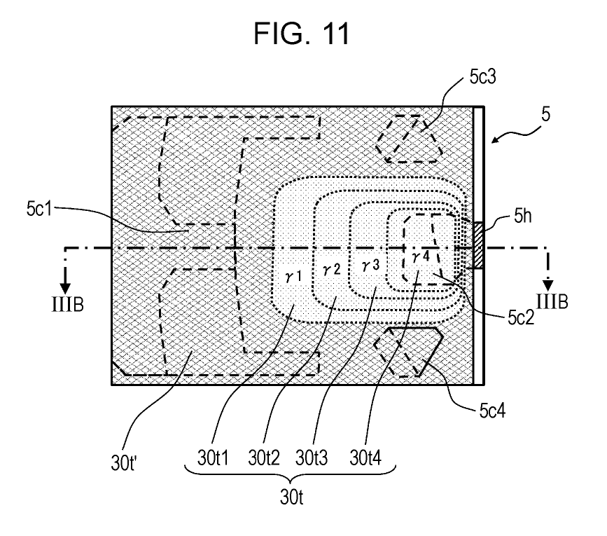

A second embodiment is an example in which, as shown in FIG. 11, in a region 30t, which is a part of a region in which a lubricant layer 30 is formed, the value indicating wettability is changed stepwise. Except for the above, the structure of the second embodiment is the same as that of the first embodiment. FIG. 11 is a plan view viewed from a air bearing surface 5f side of a slider 5 according to the second embodiment.

Referring to FIG. 11, regions 30 μl to 30t4 are regions in which wettability is changed stepwise. The amount γ of xenon excimer light irradiated for curing is changed for the regions 30t1 to 30t4 as described below. According to this embodiment, the irradiation time of the energy ray is decreased in the order of the regions 30t1 to 30t4. As a result, the SFE value of the surface provided with the lubricant layer 30 increases stepwise in the order of the regions 30t1 to 30t4.

Region 30t′: irradiation time of energy ray=60 [s], SFE value γ1=14.3 [mN/m];

Region 30t1: irradiation time of energy ray=40 [s], SFE value γ1=16.4 [mN/m];

Region 30t2: irradiation time of energy ray=20 [s], SFE value γ2=17.9 [mN/m];

Region 30t3: irradiation time of energy ray=10 [s], SFE value γ3=22.2 [mN/m];

Region 30t4: irradiation time of energy ray=3 [s], SFE value γ4=27.6 [mN/m].

As described above, in the structure according to the second embodiment, as shown in FIG. 11, the value indicating wettability is changed stepwise in the region 30t, which is a part of the region in which the lubricant layer 30 is formed. Specifically, the wettability value is set so as to increase stepwise from the outer region toward the inner region. The structure is not necessarily limited to the one described above. Any structure may be employed as long as the structure has a region provided with a lubricant layer 30 or a region 30t, which is a part of the region, in which wettability increases stepwise from an air inflow end (end of air inflow side of the slider 5) toward an air outflow end (end of air outflow side of the slider 5). Consequently, in the surface of the lubricant layer 30, molecules of the resin accumulate in the vicinity of the magnetic head 5h, and thus it is possible to more efficiently replenish the abraded portion of the lubricant layer 30.

What is claimed is:

1. A head slider comprising:
a slider body having a air bearing surface;
a magnetic head provided on the slider body; and
a lubricant layer bonded on the air bearing surface, the lubricant layer being composed of a fluorocarbon resin,
wherein, in the air bearing surface on which the lubricant layer is bonded, a first region has a higher value indicating wettability than a second region, which is a region other than the first region.

2. The head slider according to claim 1, wherein the first region is irradiated with a smaller amount of an energy ray than the second region.

3. The head slider according to claim 1, wherein the air bearing surface has a protrusion, and the lubricant layer is bonded in a region including the protrusion.

4. The head slider according to claim 1, wherein the value indicating wettability on the air bearing surface is higher than the value indicating wettability of the fluorocarbon resin.

5. The head slider according to claim 2, wherein the energy ray is ultraviolet light.

6. The head slider according to claim 1, wherein the fluorocarbon resin is a perfluoropolyether.

7. The head slider according to claim 1, wherein the magnetic head is disposed on an air outflow end of the slider body, and the value indicating wettability on the air bearing surface increases stepwise from an air inflow end toward the air outflow end.

8. The head slider according to claim 1, wherein the value indicating wettability is a surface free energy value.

9. A magnetic disk device comprising:
a magnetic recording medium provided with a first lubricant layer composed of a resin; and
a head slider,
wherein the head slider includes
a slider body having a air bearing surface,
a magnetic head provided on the slider body, and
a second lubricant layer bonded on the air bearing surface, the second lubricant layer being composed of a fluorocarbon resin,
wherein, in the air bearing surface on which the second lubricant layer is bonded, a first region has a higher value indicating wettability than a second region, which is a region other than the first region.

10. The magnetic disk device according to claim 9, wherein the first region is irradiated with a smaller amount of an energy ray than the second region.

11. A method for producing a head slider including a slider body having a air bearing surface and a magnetic head provided on the slider body, the method comprising:
applying a fluorocarbon resin to the air bearing surface; and
irradiating the air bearing surface provided with the fluorocarbon resin with an energy ray,
wherein, in irradiating the air bearing surface, a region in the air bearing surface provided with the fluorocarbon resin is selectively irradiated with a small amount of the energy ray.

12. The method for producing the head slider according to claim 11, wherein the air bearing surface has a protrusion, and in applying the fluorocarbon resin, a lubricant layer is formed in a region including the protrusion.

13. The method for producing the head slider according to claim 11, wherein a value indicating wettability on the air bearing surface is higher than the value indicating wettability of the fluorocarbon resin.

14. The method for producing the head slider according to claim 11, wherein the energy ray is ultraviolet light.

15. The method for producing the head slider according to claim 11, wherein the fluorocarbon resin is a perfluoropolyether.

16. The method for producing the head slider according to claim 11, wherein the magnetic head is disposed on an air outflow end of the slider body, and the irradiation amount of an energy ray is decreased stepwise from an air inflow end toward the air outflow end.
